(19) United States
(12) Patent Application Publication
(10) Pub. No.: US 2021/0228450 A1
(43) Pub. Date: Jul. 29, 2021

(54) Ergonomic Bottle

(71) Applicant: Admar International, Inc., Monroe, LA (US)

(72) Inventors: Nouri Edward Hakim, Monroe, LA (US); Jacob M. Sclare, Calhoun, LA (US)

(21) Appl. No.: 16/847,252

(22) Filed: Apr. 13, 2020

Related U.S. Application Data
(60) Provisional application No. 62/966,617, filed on Jan. 28, 2020.

(51) Int. Cl. A61J 11/04; A61J 9/06

(52) U.S. Cl. CPC A61J 11/04; A61J 2205/40; A61J 9/0623

(57) ABSTRACT

The present invention is directed to an ergonomic bottle comprised of a container having sidewalls and a bottom defining a liquid holding space. The sidewalls form an open end with a neck. The sidewalls further comprise indents that facilitate grasping the container by a user. The ergonomic bottle of the present invention further comprises an ergonomic nipple having an alignment mark indicating the orientation of the ergonomic nipple for optimum use. The ergonomic bottle of the present invention has a collar adapted to fasten to the neck and for receiving the ergonomic nipple. The collar has indicia indicating optimum alignment of the ergonomic nipple and indents of the container.

This application claims the benefit of U.S. provisional patent application Ser. No. 62/966,617, filed Jan. 28, 2020, which is incorporated herein by reference in its entirety.

### FIELD OF THE DISCLOSURE

The present disclosure relates generally to bottles and, more particularly, to an ergonomic bottle.

### BACKGROUND

Improved nursing bottles are outfitted with ergonomic nipples and ergonomic containers. Generally, ergonomic nipples and containers are not completely symmetric and have a specific orientation. A problem arises when the orientations of the nipple and container do not align. This problem is aggravated if a handle assembly is added to the bottle. A need has arisen for an improved ergonomic bottle.

### SUMMARY

The present invention overcomes the disadvantages of the prior art and provides for an improved ergonomic bottle. The ergonomic bottle of the present invention comprises a container having sidewalls and a bottom defining a liquid holding space. The sidewalls form an open end with a neck. The sidewalls further comprise indents that facilitate grasping the container by a user. The ergonomic bottle of the present invention further comprises a nipple having an alignment mark indicating the orientation of the nipple for optimum use. The ergonomic bottle of the present invention has a collar adapted to fasten to the neck and for receiving the nipple. The collar has indicia indicating optimum alignment of the nipple and container. In another embodiment, the ergonomic bottle further comprises a handle adjacent to the collar. In another embodiment, the collar indicia is a notch. In another embodiment, the nipple alignment mark is a tab. In another embodiment, the collar indicia is a notch and the nipple alignment mark is a tab, and the notch and tab are configured to align. In another embodiment, the nipple has a plurality of alignment marks. In another embodiment, the collar has a plurality of indicia. In another embodiment, the ergonomic bottle further comprises a handle. In another embodiment, the handle has notches that align with tabs fixed to the collar.

In another embodiment, an ergonomic bottle comprises a container adapted for holding a liquid and defined by sidewalls and a bottom with an opening defined by a neck at an end opposite the bottom. The sidewalls have an external surface for grasping by a user and the external surface has a pair of indents oppositely aligned. An ergonomic nipple is provided having a wide side and a narrow side and a nipple tab aligned with either the wide side or the narrow side. A collar is adapted for receiving the ergonomic nipple and forming a seal with the neck and having a collar tab adapted to align with the nipple tab and the container so that the ergonomic nipple is aligned with the container sidewall indents. In another embodiment, the ergonomic nipple is constructed of silicone. In another embodiment, the ergonomic nipple is constructed of a flexible material. In another embodiment, the collar and container are formed of a hard material.

In another embodiment, an ergonomic bottle comprises a container, a collar and nipple.

The container is formed of a sidewall and a bottom with an opening defined by a neck opposite the bottom, the sidewall and bottom defining a liquid holding space for holding liquid, the sidewalls having indents formed on a surface opposite one another.

The collar is adapted for receiving a nipple and forming a seal with the neck. The nipple has a base with at least one alignment mark formed thereon. The collar has at least one indicia that when aligned with the alignment mark indicates alignment between the nipple and the indents. In another embodiment, the nipple further comprises tabs that align with notches on the collar. In another embodiment, the collar has at least two indicia indicating two alignments, one for child self-feeding and a second for care giver feeding. In another embodiment, the nipple is formed of a flexible material. In another embodiment, the ergonomic bottle further comprises an ergonomic nipple. In another embodiment, the container and collar are constructed of a non-flexible material. In another embodiment, the ergonomic bottle has a handle.

### BRIEF DESCRIPTION OF THE DRAWINGS

Many aspects of the disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIG. 1 is a view of an ergonomic bottle illustrating an embodiment of the present invention;

FIG. 2 is a second view of the ergonomic bottle shown in FIG. 1;

FIG. 3 is an illustration of an alternative embodiment of a nipple and collar for use in the present invention.

### DETAILED DESCRIPTION OF THE EMBODIMENTS

This application is related to U.S. provisional patent applications Ser. No. 62/966,615, filed Jan. 28, 2020, for No Colic Bottle and Ser. No. 62/966,620, filed Jan. 28, 2020, for Method and Apparatus for Self-Sterilizing a Bottle, and U.S. non-provisional applications Ser. No. ______ , filed ______ , for No

Colic Bottle and serial number ______ , filed ______ , for Method and Apparatus for Self-Sterilizing a Bottle which are incorporated herein by reference in their entirety.

Reference is now made in detail to the description of the embodiments as illustrated in the drawings. While several embodiments are described in connection with these drawings, there is no intent to limit the disclosure to the embodiment or embodiments disclosed herein. On the contrary, the intent is to cover all alternatives, modifications, and equivalents.

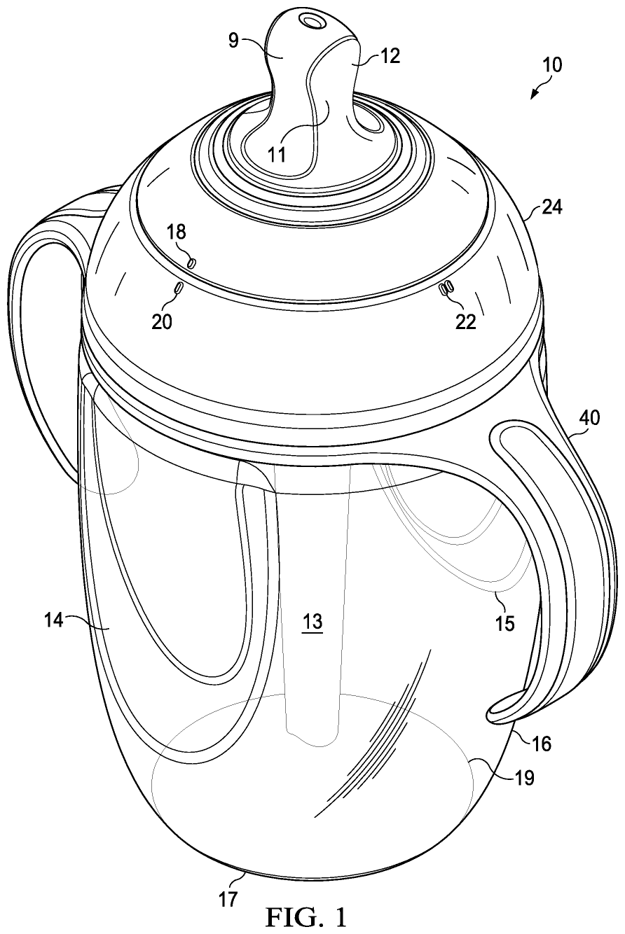

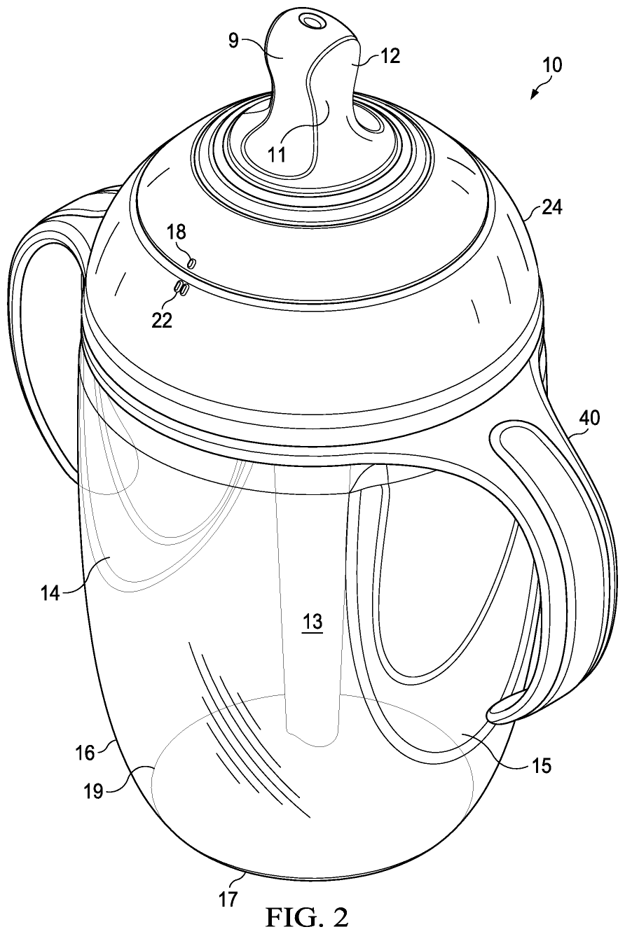

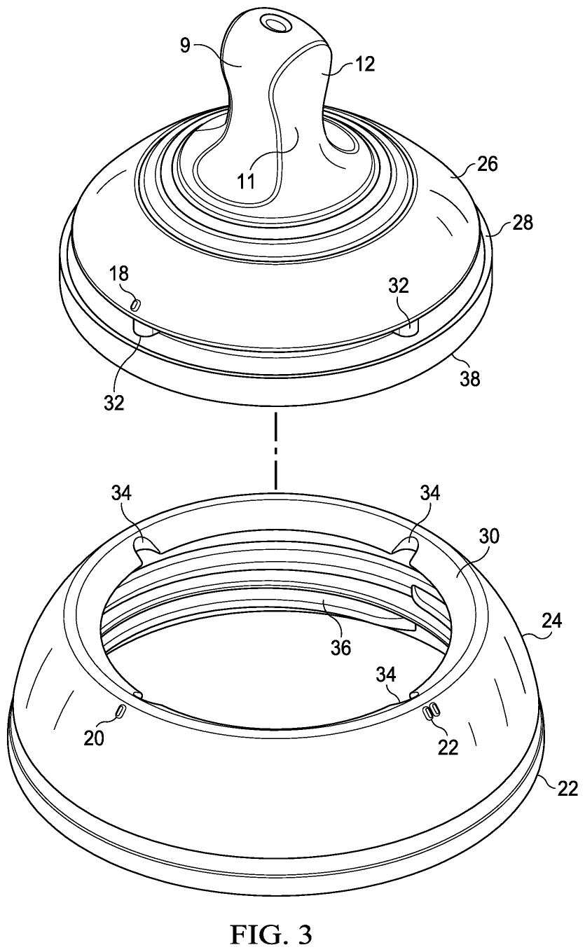

Referring now to FIGS. 1 and 2, two views of an ergonomic bottle illustrating an embodiment of the present invention, ergonomic bottle 10 is shown in a first configuration, FIG. 1, and in a second configuration, FIG. 2. In the first configuration, nipple 12 is positioned relative to indents 14 on container 16 so that a child can grasp ergonomic bottle 10 with both hands. In the preferred embodiment, nipple 12 is preferably an ergonomic nipple having a wide side 9 and a narrow side 11. Container 16 has sidewalls 15 and bottom 17 and a liquid holding space 13, for holding a liquid, defined by sidewalls 15 and bottom 17. Indents 14 are positioned on a surface 19 of sidewalls 15. In the preferred embodiment, two indents 14 are provided on sidewalls 15 opposite on another. Container 16 has an open end, opposite bottom 17, defined by a neck (not shown) that includes threads (not shown) that are complimentary to threads 36 of collar 24, shown in FIG. 3. In the second configuration, nipple 12 is positioned relative to indents 14 on container 16 so that a child care provider, such as a parent, can grasp container 16 at indents 14 in one hand. In both configurations, nipple 12 is ideally oriented to the child's mouth for optimum use. Proper orientation of nipple 12 and container 16 are facilitated by aligning an alignment mark 18 on nipple 12 with either first indicia 20 or second indicia 22 on collar 24. In the preferred embodiment, first indicia 20 aligns nipple 12 and container 16 for use by a child with two hands and second indicia 22 aligns nipple 12 and container 16 for use by a care provider using one hand. In a preferred embodiment, ergonomic bottle 10 may be outfitted with handle 40 adjacent to collar 24. Handle 40 can be configured with notches that align with corresponding tabs on collar 24 so that handle 40 is optimally aligned for grasping by a user.

Referring now to FIG. 3, an alternative embodiment of a nipple and collar for use in the present invention, nipple 12 is shown with base 26 having groove 28 that is complimentarily press fitted over rim 30 of collar 24 to form a tight seal between nipple 12 and collar 24. In the preferred embodiment, nipple 12 includes flange 38 that forms a tight seal between nipple 12 and container 16 at the neck of the open end. Alignment mark 18 is shown on base 26 aligned with first indicia 20 on collar 24. In an alternative embodiment, nipple 12 includes one or more tabs 32 that align with notches 34 that limit the orientation of nipple 12 to only two configurations. In the embodiment omitting tabs 32 and notches 34, a user has to align alignment mark 18 with either the first or second indicia 20 and 22 by sight. The use of tabs 32 and notches 34 substantially facilitate the alignment process. Collar 24 is shown with threads 36 that are adapted to mate with corresponding threads on container 16. Threads 36 on collar 24 work with the threads on container 16 to align collar 24 with a fixed orientation relative to container 16 indicated by first and second indicia 20 and 22.

Although exemplary embodiments have been shown and described, it will be clear to those of ordinary skill in the art that a number of changes, modifications, or alterations to the disclosure as described may be made. All such changes, modifications, and alterations should therefore be seen as within the scope of the disclosure.

What is claimed is:

1. An ergonomic bottle comprising:
A container having sidewalls and a bottom defining a liquid holding space, the sidewalls forming an open end with a neck, the sidewalls further comprising indents that facilitate grasping the container by a user;
A nipple having an alignment mark indicating the orientation of the nipple for optimum use; and
A collar adapted to fasten to the neck and for receiving the nipple, the collar having indicia indicating optimum alignment of the nipple and container.

2. The ergonomic bottle of claim 1, further comprising a handle adjacent to the collar.

3. The ergonomic bottle of claim 1, wherein the collar indicia is a notch.

4. The ergonomic bottle of claim 1, wherein the nipple alignment mark is a tab.

5. The ergonomic bottle of claim 1, wherein the collar indicia is a notch and the nipple alignment mark is a tab, and the notch and tab are configured to align.

6. The ergonomic bottle of claim 1, wherein the nipple has a plurality of alignment marks.

7. The ergonomic bottle of claim 1, wherein the collar has a plurality of indicia.

8. The ergonomic bottle of claim 1, further comprising a handle.

9. The ergonomic bottle of claim 1, further comprising a handle with notches that align with tabs fixed to the collar.

10. A ergonomic bottle comprising:
A container adapted for holding a liquid and defined by sidewalls and a bottom with an opening defined by a neck at an end opposite the bottom, the sidewalls having an external surface for grasping by a user, the external surface having a pair of indents oppositely aligned;
An ergonomic nipple having a wide side and a narrow side and a nipple tab aligned with either the wide side or the narrow side; and
A collar adapted for receiving the ergonomic nipple and forming a seal with the neck and having a collar tab adapted to align with the ergonomic nipple tab and the container so that the ergonomic nipple is aligned with the container sidewall indents.

11. The ergonomic bottle of claim 10, wherein the ergonomic nipple is constructed of silicone.

12. The ergonomic bottle of claim 10, wherein the ergonomic nipple is constructed of a flexible material.

13. The ergonomic bottle of claim 10, wherein collar and container are formed of a hard material.

14. A ergonomic bottle comprising:
A container, a collar and nipple;
The container formed of a sidewall and a bottom with an opening defined by a neck opposite the bottom, the sidewall and bottom defining a liquid holding space for holding liquid, the sidewalls having indents formed on a surface opposite one another;
The collar adapted for receiving a nipple and forming a seal with the neck;
The nipple having a base with at least one alignment mark formed thereon; and
The collar having at least one indicia that when aligned with the alignment mark indicates alignment between the nipple and the indents.

15. The ergonomic bottle of claim 14, wherein the nipple further comprises tabs that align with notches on the collar.

16. The ergonomic bottle of claim 14, wherein the collar has at least two indicia indicating two alignments, one for child self-feeding and a second for care giver feeding.

17. The ergonomic bottle of claim 14, wherein the nipple is formed of a flexible material.

18. The ergonomic bottle of claim 14, further comprising an ergonomic nipple.

19. The ergonomic bottle of claim 14, wherein the container and collar are constructed of a non-flexible material.

20. The ergonomic bottle of claim 14, further comprising a handle.
